(19) United States
(12) Patent Application Publication
(10) Pub. No.: US 2017/0090485 A1
(43) Pub. Date: Mar. 30, 2017

(54) FLOW RATE CALCULATING DEVICE, FLOW RATE CALCULATION METHOD AND FLOW RATE CONTROLLING DEVICE

(71) Applicant: Azbil Corporation, Tokyo (JP)

(72) Inventors: Tomofumi OHASHI, Tokyo (JP); Hideaki SOMEYA, Tokyo (JP)

(21) Appl. No.: 15/277,502

(22) Filed: Sep. 27, 2016

(30) Foreign Application Priority Data
Sep. 30, 2015 (JP) 2015-192770

(51) Int. Cl. G05D 7/06; G05B 15/02

(52) U.S. Cl. CPC G05D 7/0635; G05D 7/0623; G05B 15/02

(57) ABSTRACT

A method and system for measuring and controlling a flow rate of a valve by correcting a valve opening measurement value θpv with the use of a correction value α corresponding to an amount of twist of a valve stem that is determined according to the valve opening measurement value θpv and a differential pressure detection value ΔP, and calculating a flow rate of a fluid flowing in a pipeline on the basis of a corrected valve opening θpv′ and the differential pressure detection value ΔP. The calculated flow rate of the fluid is set as a measured flow rate Qpv, and the amount of rotation of the valve stem is controlled so that the measured flow rate Qpv matches a set flow rate Qsp.

### CROSS-REFERENCE TO RELATED APPLICATION

The present application claims the benefit of and priority to Japanese Patent Application No. 2015-192770, filed on Sep. 30, 2015, the entire contents of which are incorporated by reference herein.

### TECHNICAL FIELD

The present disclosure relates to a flow rate calculating device and a flow rate calculation method for calculating a flow rate of a fluid flowing in a flow channel in which an opening/closing amount of a valve member can be adjusted, and a flow rate controlling device that controls the flow rate of the fluid flowing in the flow channel with the use of the calculated flow rate.

### BACKGROUND

Up to now, both of a flow meter and a valve are disposed in a pipeline, and the opening degree of the valve (valve opening) is controlled on the basis of a flow rate measured by the flow meter. However, in such a method, both of the flow meter and the valve must be installed, and the costs are increased. Under this circumstance, a flow rate control valve equipped with both functions of a flow measurement function and a valve opening control function has been desired and put into practical use (for example, refer to PTL 1 and PTL 2).

The flow rate control valve includes a valve main body having a pipeline forming a flow channel in which a fluid flows and a valve member for adjusting a flow rate (opening and closing amount of the flow channel) of the fluid flowing in the pipeline, and an actuator for controlling the valve opening degree of the valve member attached to the valve main body. The actuator includes a motor that rotates a valve stem coupled with the valve member. A CPU and a memory are mounted in the actuator. The valve main body includes a first pressure sensor for measuring a fluid pressure P1 on an upstream side of the valve member, a second pressure sensor for measuring a fluid pressure P2 on a downstream side of the valve member, and a valve opening sensor for detecting a valve opening θ of the valve member according to a rotational position of the valve stem.

The CPU of the actuator acquires a differential pressure ΔP of the valve member by detecting a pressure difference between the fluid pressure P1 from the first pressure sensor and the fluid pressure P2 from the second pressure sensor; reads, from a characteristic table stored in the memory, a flow rate coefficient Cv corresponding to the combination of the valve opening degree θ and the differential pressure ΔP from the valve opening sensor; and calculates a flow rate Q of the fluid flowing in the pipeline of the valve main body on the basis of the flow rate coefficient Cv and the differential pressure ΔP through the following Formula (1). Then, the CPU compares the calculated flow rate Q as a measured flow rate Qpv with a set flow rate Qsp, and controls the amount of rotation of the valve stem so that the measured flow rate Qpv matches the set flow rate Qsp.

Q=A*Cv*(ΔP)^{1/2} (1)

where A is a constant.

### CITATION LIST

### Patent Literature

[PTL 1] JP-A-2009-115271
[PTL 2] JP-A-2010-108338 (U.S. Pat. No. 5,286,032)
[PTL 3] JP-A-2009-245096

### SUMMARY

However, in a flow rate control valve of the type that rotates the valve stem coupled with the valve member (e.g., a rotary valve), the valve stem is twisted due to a pressure of the flowing fluid. The valve stem is twisted due to a frictional resistance between a sheet for shutting off the fluid and supporting the valve stem (or the bearing) and the valve member even when the valve member is rotated. Further, when the differential pressure is generated, the pressure is applied to the valve member, and the frictional resistance between the valve body and the sheet that supports the valve stem (or the bearing) is increased. The frictional resistance causes the twist of the valve stem to be further increased.

When the valve stem is twisted, an error occurs between the measured valve opening (valve opening measurement value) of the valve member that is detected from the rotational position of the valve stem, and the actual valve opening (valve opening actual value). For this reason, the error caused by the twist of the valve stem occurs in the measured flow rate Qpv obtained through the above Formula (1), and a precision in the flow rate control is decreased.

The present disclosure has been made to solve the above problem, and an object of the present disclosure is to provide a flow rate calculating device and a flow rate calculation method which are capable of enhancing a measurement precision in a flow rate. In addition, another object of the present disclosure is to provide a flow rate controlling device which is capable of realizing a flow rate control with high precision.

In order to achieve the above object, a flow rate calculating device according to the present disclosure includes: a valve opening correction portion that obtains a correction value corresponding to the amount of twist of a valve stem at that time according to at least one of a valve opening measurement value and a differential pressure detection value, and corrects the valve opening measurement value with the use of the correction value when a valve opening of a valve member detected according to a rotational position of the valve stem coupled with the valve body that adjusts the opening and closing amount of a flow channel in which a fluid flows is set as the valve opening measurement value, and a differential pressure of the valve body detected as a pressure difference between a primary fluid pressure and a secondary fluid pressure of the valve body is set as the detected differential pressure value; and a flow rate calculation portion that calculates a flow rate of the fluid flowing in the flow channel on the basis of the valve opening corrected by the valve opening correction portion and the differential pressure detection value.

A flow rate calculation method according to the present disclosure includes: a valve opening acquisition step of acquiring a valve opening of a valve body detected according to a rotational position of a valve stem coupled with the valve body that adjusts the opening and closing amount of a flow channel in which a fluid flows as a valve opening measurement value; a differential pressure acquisition step of acquiring a differential pressure of the valve body detected as a pressure difference between a primary fluid pressure and a secondary fluid pressure of the valve body as a differential pressure detection value; a valve opening correction step of obtaining a correction value corresponding to the amount of twist of the valve stem at that time according to at least one of the valve opening measurement value acquired by the valve opening acquisition step and the differential pressure detection value acquired by the differential pressure acquisition step, and correcting the valve opening measurement value with the use of the correction value; and a flow rate calculation step of calculating a flow rate of the fluid flowing in the flow channel on the basis of the valve opening corrected by the valve opening correction step and the differential pressure detection value acquired by the differential pressure acquisition step.

Also, the flow rate controlling device according to the present disclosure includes: a valve opening correction portion that obtains a correction value corresponding to the amount of twist of a valve stem at that time according to at least one of a valve opening measurement value and a differential pressure detection value, and corrects the valve opening measurement value with the use of the correction value when a valve opening of a valve body detected according to a rotational position of the valve stem coupled with the valve body that adjusts the opening and closing amount of a flow channel in which a fluid flows is set as the valve opening measurement value, and a differential pressure of the valve body detected as a pressure difference between a primary fluid pressure and a secondary fluid pressure of the valve body is set as the differential pressure detection value; a flow rate calculation portion that calculates a flow rate of the fluid flowing in the flow channel on the basis of the valve opening corrected by the valve opening correction portion and the differential pressure detection value; and a valve opening controlling portion that controls the amount of rotation of the valve stem so that a measured flow rate matches a set flow rate when the flow rate of the fluid calculated by the flow rate calculation portion is set as the measured flow rate.

Meanwhile, in the present disclosure, a change in the valve opening of the valve body may be determined, the correction value corresponding to the amount of twist of the valve stem at that time may be obtained according to at least one of the valve opening measurement value and the differential pressure detection value, and the determined changing direction of the valve opening, and the valve opening measurement value may be corrected with the use of the correction value.

### BRIEF DESCRIPTION OF THE DRAWINGS

FIG. 1 is an instrumentation diagram illustrating an example of an air conditioning control system using a rotary valve according to an example of the present disclosure.

FIG. 2 is a diagram illustrating a main portion of a flow rate control valve (rotary valve) used in the air conditioning control system illustrated in FIG. 1 according to an example (first example).

FIG. 3 is a diagram illustrating a correction table used in a flow rate control valve illustrated in FIG. 2.

FIG. 4 is a diagram illustrating a characteristic table used in the flow rate control valve illustrated in FIG. 2.

FIG. 5 is a diagram illustrating an error δ occurring between an actual valve opening (valve opening actual value) θpr of a valve member and a measured valve opening (valve opening measurement value) θpv of the valve member detected according to a rotational position of a valve stem being eliminated in the flow rate control valve illustrated in FIG. 2.

FIG. 6 is a diagram illustrating a main portion of a flow rate control valve according to a second example.

FIG. 7A is a diagram illustrating a correction table for changing a closing direction used in a flow rate control valve according to the second example.

FIG. 7B is a diagram illustrating a correction table for changing an opening direction used in the flow rate control valve according to the second example.

FIG. 8A is a diagram corresponding to FIG. 5 when the opening degree is changed in the closing direction in the flow rate control valve according to the second example.

FIG. 8B is a diagram corresponding to FIG. 5 when the opening degree is changed in the opening direction in the flow rate control valve according to the second example.

FIG. 9 is a diagram illustrating a relationship between the valve opening and the amount of twist of the valve member.

FIG. 10 is a diagram illustrating a relationship between a differential pressure and the amount of twist of the valve member.

### DETAILED DESCRIPTION

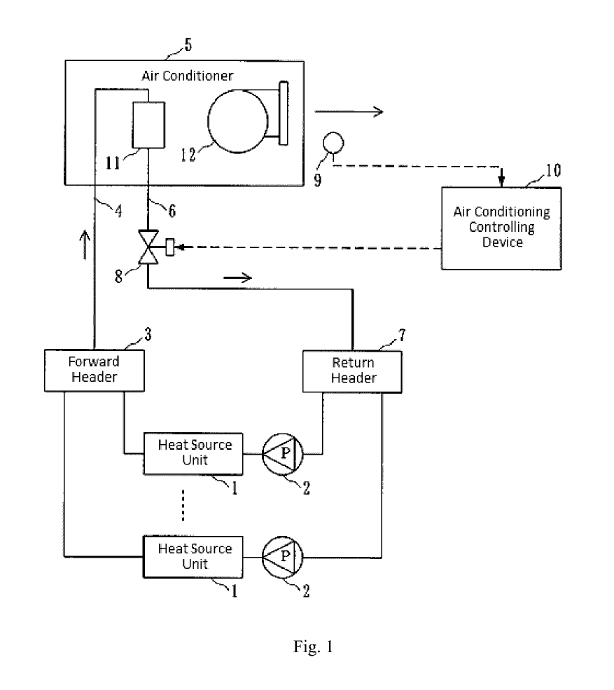

Hereinafter, examples of the present disclosure will be described in detail with reference to the accompanying drawings. FIG. 1 is an instrumentation diagram illustrating an example of an air conditioning control system using a rotary valve according to an example of the present disclosure.

Referring to FIG. 1, reference numeral 1 denotes heat source units each for cooling or heating water to generate cold or hot water, 2 is pumps each for conveying the cold or hot water generated by the corresponding heat source unit 1, 3 is a forward header for mixing the cold water or the hot water from the multiple heat source units 1 together, 4 is a forward water pipeline, 5 is an air conditioner that receives a supply of the cold or hot water sent from the forward header 3 through the forward water pipeline 4, 6 is a return water pipeline, 7 is a return header to which the cold or hot water subjected to a heat exchange in the air conditioner 5 and transmitted through the return water pipeline 6 is returned, 8 is a flow rate control valve (rotary valve) that controls a flow rate of the cold or hot water to be supplied to the air conditioner 5 from the forward header 3, 9 is an intake air temperature sensor for measuring a temperature of an intake air sent out from the air conditioner 5, 10 is an air conditioning controlling device, 11 is a coil of the air conditioner 5, 12 is a blower.

In the air conditioning control system, the cold water or the hot water that have been pumped by the pumps 2 and that have received a heat quantity from the respective heat source units 1 are: mixed together in the forward header 3; supplied to the air conditioner 5 through the forward water pipeline 4; passed through the air conditioner 5; led to the return header 7 as a return water through the return water pipeline 6; and, again, pumped by the pumps 2. The cold or hot water is circulated in the above route. For example, in the case of cooling operation, cold water is generated in each of the heat source units 1, and the cold water is circulated. In the case of heating operation, hot water is generated in each of the heat source units 1, and the hot water is circulated.

The air conditioner 5 cools or heats a mixture of an air (return air) returning from a control target area to the air conditioning control system with an outside air by the coil 11 through which the cold or hot water passes, and then feeds the cooled or heated air to the control target area through the blower 12 as an intake air. The air conditioner 5 is an air conditioner of a single type using the common coil 11 in the cooling operation and the heating operation, and the rotary valve according to the example of the present disclosure is installed as the flow rate control valve 8 in the return water pipeline 6 of the cold or hot water circulated into the air conditioner 5.

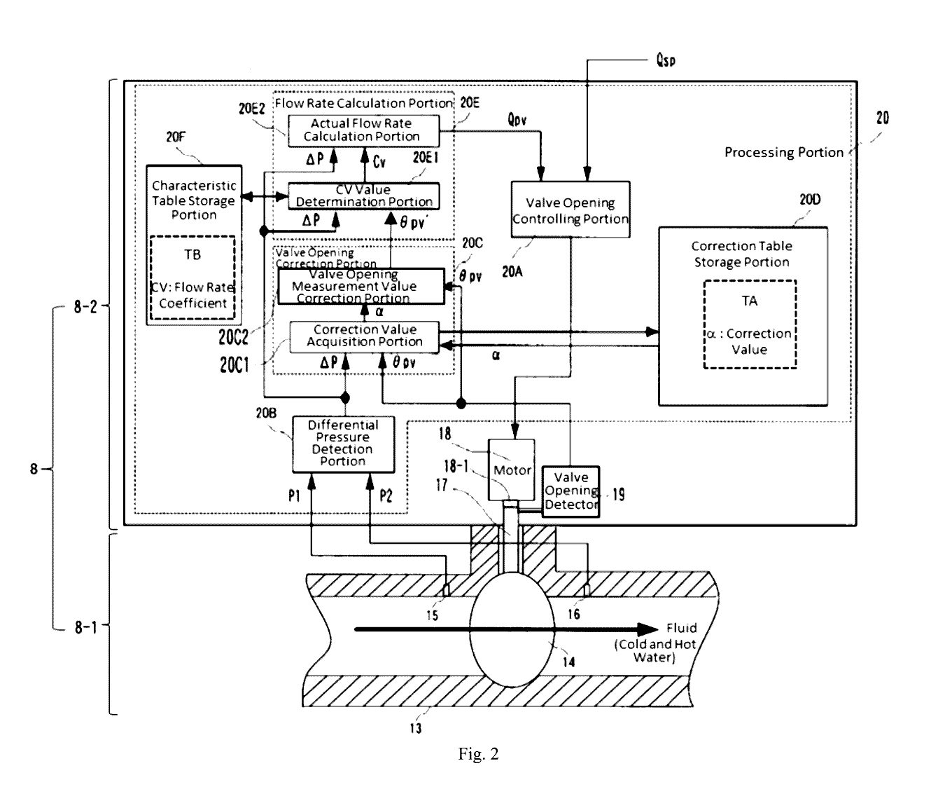

FIG. 2 is a diagram illustrating a main portion of the flow rate control valve 8 used in the air conditioning control system. The flow rate control valve 8 includes a valve main body 8-1 and an actuator 8-2 attached to the valve main body 8-1.

The valve main body 8-1 includes a pipeline 13 defining a flow channel in which the cold or hot water that has passed through the air conditioner 5 flows, a valve member 14 for adjusting a flow rate (opening and closing amount of flow channel) of the fluid flowing in the pipeline 13, a primary side pressure sensor 15 for detecting a primary side fluid pressure P1 in the pipeline 13 is disposed on an upstream side of the valve member 14, and a secondary side pressure sensor 16 for detecting a secondary side fluid pressure P2 in the pipeline 13 is disposed on a downstream side of the valve member 14.

The actuator 8-2 includes a motor 18 that rotates a valve stem 17 coupled with the valve member 14, a valve opening detector 19 that detects a valve opening θpv of the valve member 14 according to a rotational position (rotational position in the vicinity of a drive shaft 18-1) of the valve stem 17 coupled with the drive shaft 18-1 of the motor 18, and a processing portion 20.

The processing portion 20 includes a valve opening controlling portion 20A, a differential pressure detection portion 20B, a valve opening correction portion 20C, a correction table storage portion 20D, a flow rate calculation portion 20E, and a characteristic table storage portion 20F. The valve opening correction portion 20C includes a correction value acquisition portion 20C1 and a valve opening measurement value correction portion 20C2. The flow rate calculation portion 20E includes a Cv value determination portion 20E1 and an actual flow rate calculation portion 20E2.

The differential pressure detection portion 20B receives the primary pressure P1 of the fluid from the primary side pressure sensor 15 and the secondary pressure P2 of the fluid from the secondary side pressure sensor 16, and detects a pressure difference between the primary pressure P1 and the secondary pressure P2 as a differential pressure ΔP of the valve member 14. Meanwhile, the primary side pressure sensor 15 and the secondary side pressure sensor 16 can be replaced with a differential pressure sensor, and the differential pressure ΔP of the valve member 14 can be directly detected by the differential pressure sensor.

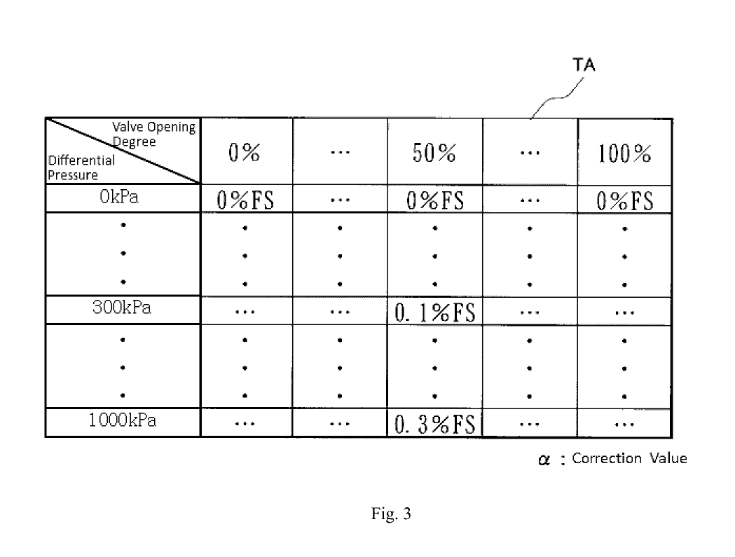

A correction table TA (refer to FIG. 3) for determining a correction value α corresponding to the amount of twist of the valve stem 17 in correspondence with the combination of the valve opening of the valve member 14 with the differential pressure of the valve member 14 at that time is stored in the correction table storage portion 20D. In the correction table TA, the correction value α is a value obtained by experiment, which is a value representing the amount of twist of the valve stem 17 estimated from the valve opening θpv of the valve member 14 (e.g., expressed in a valve opening degree percentage (%) as shown in FIG. 3) and the differential pressure ΔP of the valve member 14 at that time (e.g., in kPa) as the opening degree (% FS—rate in full scale).

Meanwhile, in the correction table TA, the correction value α corresponding to the amount of twist of the valve stem 17 may be replaced with a value represented by an angle [°], an operation time [s], an operation amount [mm], a control signal amount [V or A], or the like. In the present example, the amount of twist of the valve stem 17 is an opening value represented by % FS (rate in full scale).

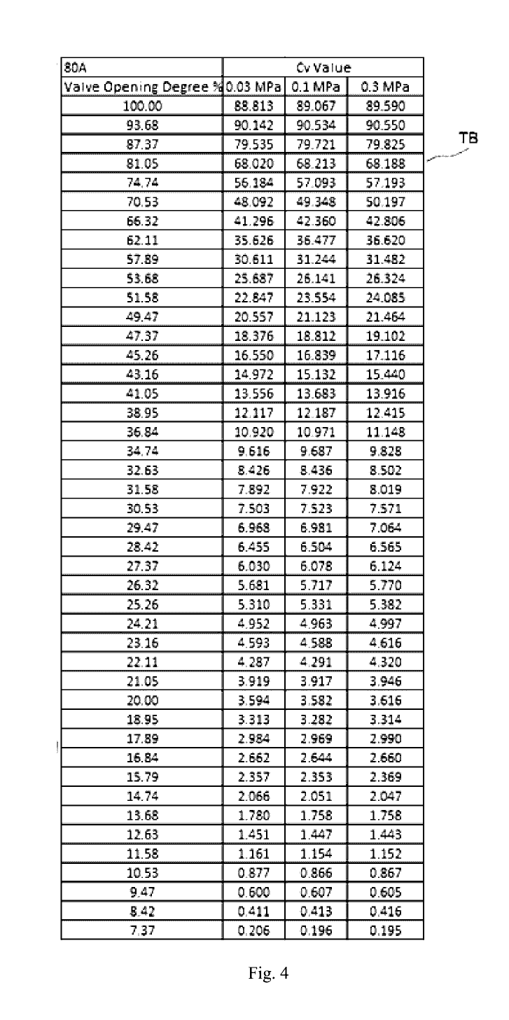

A characteristic table TB (refer to FIG. 4) that determines a flow rate coefficient Cv at that time in correspondence with the combination of the valve opening of the valve member 14 (e.g., expressed in a valve opening degree percentage (%) as shown in FIG. 4) with the differential pressure of the valve member 14 (e.g., in MPa) is stored in the characteristic table storage portion 20F. In this example, three kinds of differential pressures of the valve member 14 are provided, and the characteristic table TB that determines the flow rate coefficient Cv at that time in correspondence with the combination of the valve opening of the valve member 14 with the three kinds of differential pressures is stored therein.

In addition, in the present example, the processing portion 20 is realized by hardware including one or more processors and one or more memory devices, and one or more programs that realize various functions in cooperation with such hardware.

Hereinafter, the characteristic processing operation of the flow rate control valve 8 will be described along with the functions of the valve opening controlling portion 20A, the valve opening correction portion 20C, and the flow rate calculation portion 20E in the processing portion 20.

Meanwhile, in this example, the set flow rate Qsp is given to the flow rate control valve 8 by the air conditioning controlling device 10 so as to keep the temperature of the control target area at a setting temperature. In this case, the set flow rate Qsp from the air conditioning controlling device 10 is fed to the valve opening controlling portion 20A.

In the flow rate control valve 8, the differential pressure detection portion 20B receives the primary pressure P1 of the fluid from the primary side pressure sensor 15 and the secondary pressure P2 of the fluid from the secondary side pressure sensor 16, and detects a pressure difference between the primary pressure P1 and the secondary pressure P2 as a differential pressure ΔP of the valve member 14. The differential pressure ΔP of the valve member 14 detected by the differential pressure detection portion 20B is fed to the valve opening correction portion 20C and the flow rate calculation portion 20E as the differential pressure detection value.

The valve opening detector 19 detects the valve opening measurement value θpv of the valve member 14 according to the rotational position (rotational position in the vicinity of the drive shaft 18-1) of the valve stem 17 coupled with the drive shaft 18-1 of the motor 18. The valve opening measurement value θpv detected by the valve opening detector 19 is fed to the valve opening correction portion 20C.

In the valve opening correction portion 20C, the correction value acquisition portion 20C1 receives the valve opening measurement value θpv from the valve opening detector 19 and the differential pressure detection value ΔP from the differential pressure detection portion 20B, acquires the correction value α corresponding to the combination of the valve opening measurement value θpv with the differential pressure ΔP from the correction table TA, and feeds the acquired correction value α to the valve opening measurement value correction portion 20C2.

The valve opening measurement value correction portion 20C2 receives the valve opening measurement value θpv from the valve opening detector 19 and the correction value α from the correction value acquisition portion 20C1, and corrects the valve opening measurement value θpv with the correction value α from the valve opening detector 19 as a valve opening θpv′.

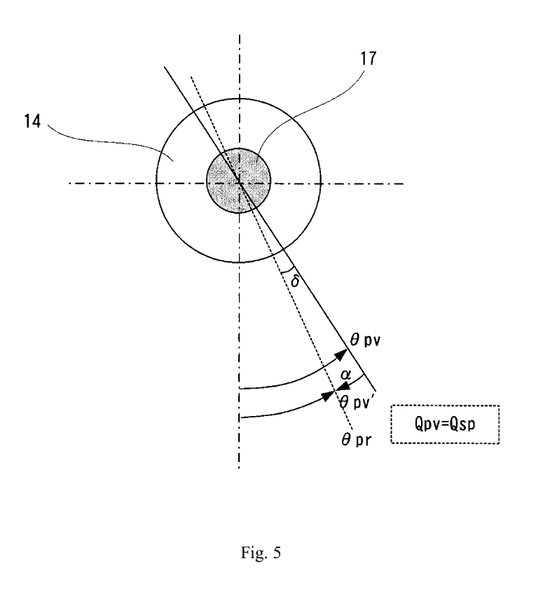

In the flow rate control valve 8, the valve stem 17 is twisted due to the pressure of the flowing fluid. For that reason, the error δ occurs between the valve opening (valve opening measurement value) θpv of the valve member 14, which is detected according to the rotational position of the valve stem 17 and the actual valve opening (valve opening actual value) θpr of the valve member 14 (refer to FIG. 5). Under the circumstance, in the present example, in the valve opening measurement value correction portion 20C2, the valve opening measurement value θpv is corrected with the use of the correction value α to allow the corrected valve opening θpv′ to match the valve opening actual value θpr so that the error δ does not occur.

For example, in a state illustrated in FIG. 5, when the valve opening (valve opening measurement value) θpv of the valve member 14, which is detected according to the rotational position of the valve stem 17, is 50%, and the differential pressure (differential pressure detection value) ΔP of the valve member 14 is 300 kPa, 0.1% FS is acquired as the correction value α from the correction table TA (FIG. 3) in the correction value acquisition portion 20C1. With the above configuration, the valve opening θpv′ corrected in the valve opening measurement value correction portion 20C2 becomes θpv′=θpv−α=50%−0.1%=49.9%, and matches the valve opening actual value θpr=49.9%.

The valve opening θpv′ corrected in the valve opening measurement value correction portion 20C2 is fed to the flow rate calculation portion 20E. In the flow rate calculation portion 20E, the Cv value determination portion 20E1 receives the differential pressure detection value ΔP from the differential pressure detection portion 20B and the corrected valve opening θpv′ from the valve opening measurement value correction portion 20C2, acquires the flow rate coefficient Cv corresponding to the combination of the differential pressure detection value ΔP with the corrected valve opening θpv′ from the characteristic table TB, and feeds the flow rate coefficient Cv to the actual flow rate calculation portion 20E2.

The actual flow rate calculation portion 20E2 receives the flow rate coefficient Cv from the Cv value determination portion 20E1 and the differential pressure detection value ΔP from the differential pressure detection portion 20B, calculates the flow rate Q of the fluid flowing in the pipeline 13 as Q=A*Cv*(ΔP)^{1/2} according to the flow rate coefficient Cv and the differential pressure ΔP, and feeds the calculated flow rate Q to the valve opening controlling portion 20A as the measured flow rate Qpv.

The valve opening controlling portion 20A receives the measured flow rate Qpv from the flow rate calculation portion 20E and the set flow rate Qsp from the air conditioning controlling device 10, and sends a command to the motor 18 so that the measured flow rate Qpv matches the set flow rate Qsp. As a result, the valve stem 17 rotates, the opening and closing amount of valve member 14 is adjusted so that the measured flow rate Qpv matches the set flow rate Qsp.

As described above, according to the present example, the valve opening measurement value θpv is corrected with the correction value α corresponding to the amount of twist of the valve stem 17 at that time which is obtained from the correction table TA, as a result of which the error δ occurring between the actual valve opening (valve opening actual value) θpr of the valve member 14 and the measured valve opening (valve opening measurement value) θpv of the valve member 14 which is detected according to the rotational position of the valve stem 17 is eliminated, the measurement precision of the flow rate is enhanced, and the flow rate control with high precision can be realized.

Meanwhile, even if the correction value α set in the correction table TA is not the opening degree [% FS], but is expressed as another value such as an angle[°], an operation time [s], an operation amount [mm], or a control signal amount [V or A], the valve opening measurement value θpv is corrected in the same manner, thereby being capable of eliminating the error δ occurring between the actual valve opening (valve opening actual value) θpr of the valve member 14 and the measured valve opening (valve opening measurement value) θpv of the valve member 14 which is detected according to the rotational position of the valve stem 17.

In addition, the present disclosure is applicable to a flow rate control valve in which upstream and downstream pressure sensors are disposed as disclosed in PTL 1, PTL 2 and PTL 3.

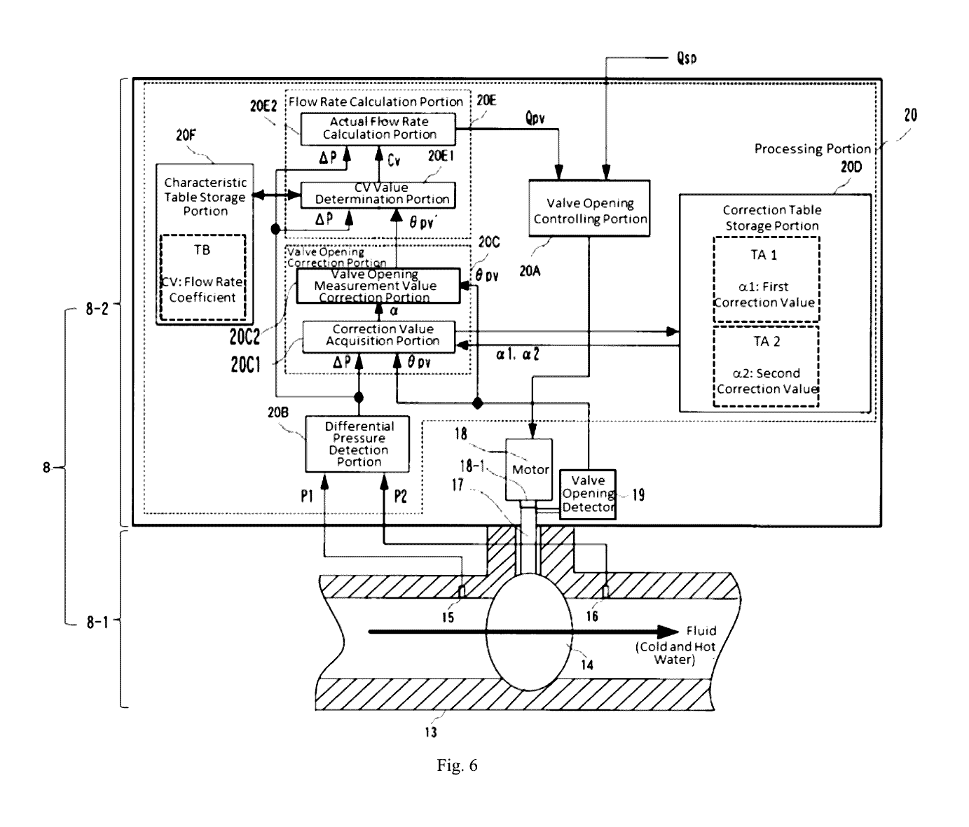

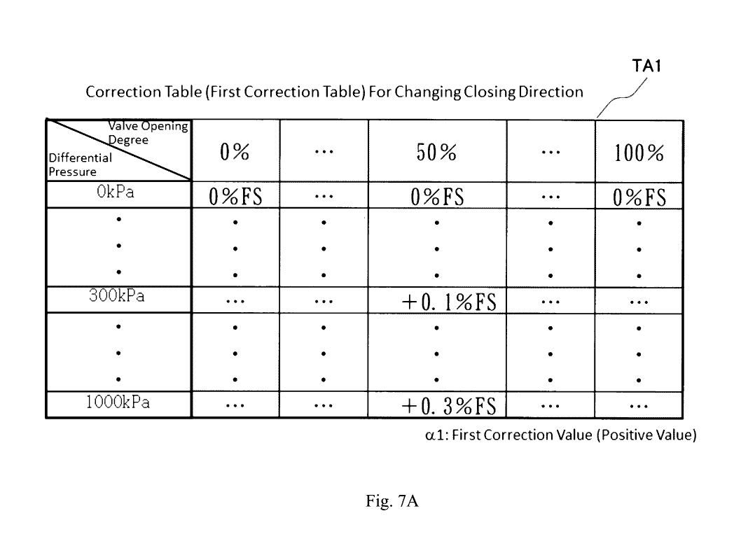

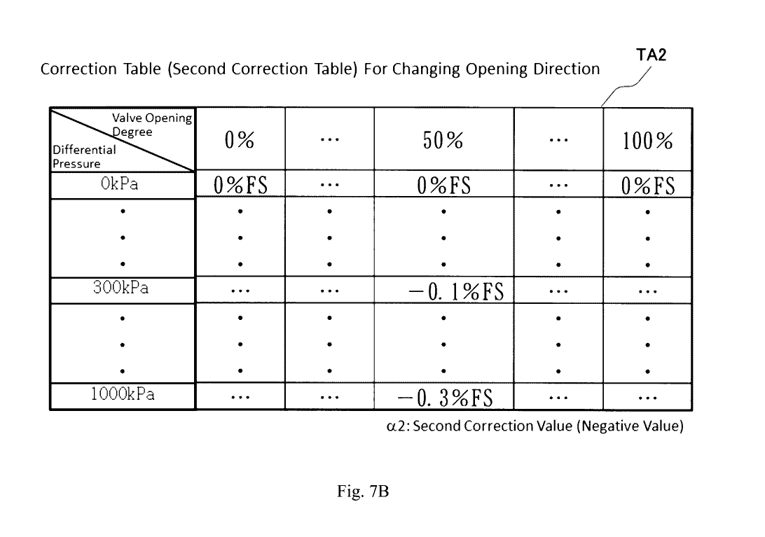

In the example (first example) illustrated in FIG. 2, one correction table is stored in the correction table storage portion 20D. Alternatively, as illustrated in FIG. 6 as a second example, taking a changing direction of a valve opening into account, two correction tables including a first correction table TA1 for changing a closing direction (refer to FIG. 7A) and a second correction table TA2 for changing an opening direction (refer to FIG. 7B) may be stored in a correction table storage portion 20D.

In that case, first correction values α1 corresponding to the combination of a valve opening of a valve member 14 with a differential pressure of the valve member 14 are set in the correction table TA1 for changing a closing direction, and each of the first valve opening correction values α1 is set as a positive value (plus value). Also, the second correction values α2 corresponding to the combination of the valve opening of the valve member 14 with the differential pressure of the valve member 14 are set in the correction table TA2 for changing an opening direction, and each of the second correction values α2 is set as a negative value (minus value).

Further, in the correction value acquisition portion 20C1, the changing direction of the valve opening is determined, and when the changing direction is changed to a closing direction of decreasing the valve opening, the first correction value α1 corresponding to the valve opening θpv detected by the valve opening detector 19 and the differential pressure ΔP detected by the differential pressure detection portion 20B is acquired from the first correction table TA1 for changing the closing direction. Further, when the changing direction is changed to an opening direction of increasing the valve opening, the second correction value α2 corresponding to the valve opening θpv detected by the valve opening detector 19 and the differential pressure ΔP detected by the differential pressure detection portion 20B is acquired from the second correction table TA2 for changing the opening direction. The acquired first correction value α1 or second correction value α2 is sent to the valve opening measurement value correction portion 20C2 as the correction value α corresponding to the amount of twist of the valve stem 17 at that time.

Meanwhile, the reason why each of the first correction values α1 in the correction table TA1 for changing the closing direction is set to the positive value, and each of the second correction values α2 in the correction table TA2 for changing the opening direction is set to negative value is as follows.

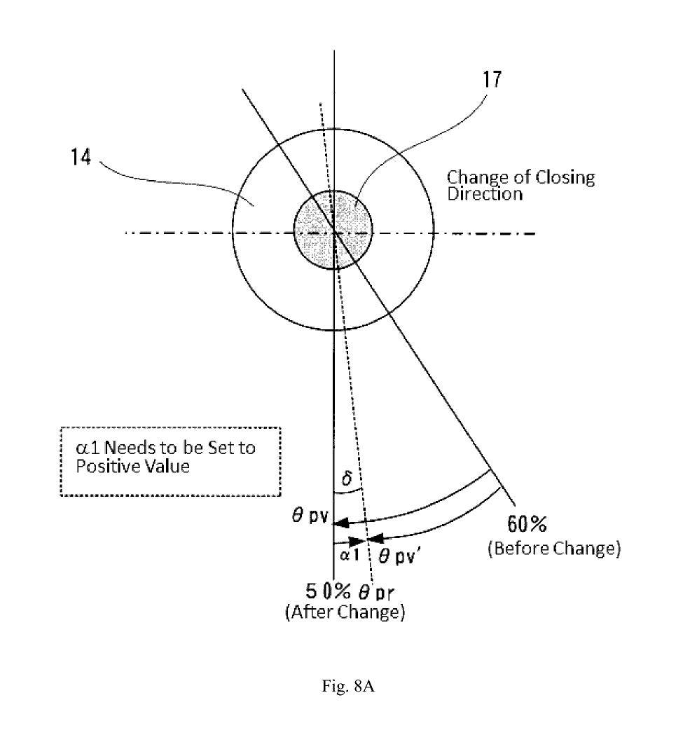

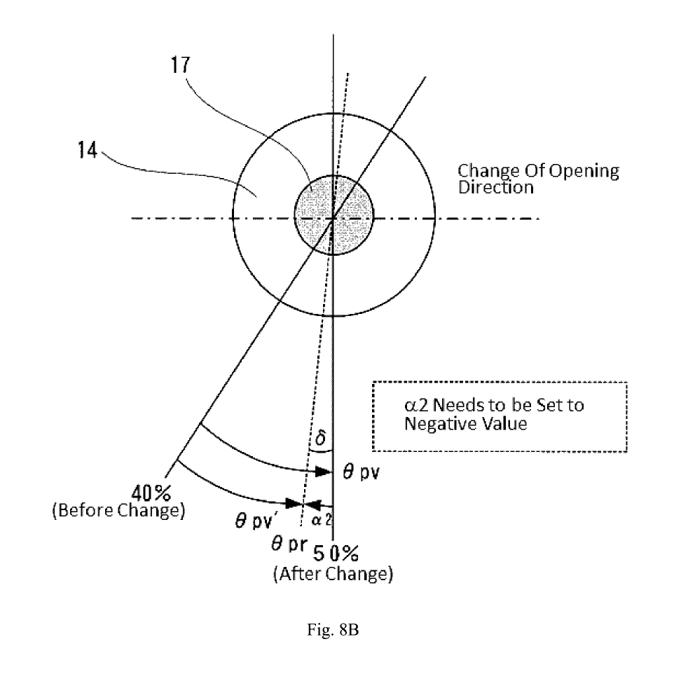

FIG. 8A is a diagram corresponding to FIG. 5 when the valve opening is changed, for example, from 60% to 50%. In that case, the error δ occurs between the actual valve opening (valve opening actual value) θpr of the valve member 14 and the measured valve opening (valve opening measurement value) θpv of the valve member 14 which is detected according to the rotational position of the valve stem 17, and there is a need to increase the measured valve opening in order to eliminate the error δ. For that reason, the first correction values α1 are set to the positive values so that the valve opening actual value θpr matches the corrected valve opening θpv′.

FIG. 8B is a diagram corresponding to FIG. 5 when the valve opening is changed, for example, from 40% to 50%. In that case, the error δ occurs between the actual opening degree (valve opening actual value) θpr of the valve member 14 and the measured opening degree (valve opening measurement value) θpv of the valve member 14 which is detected according to the rotational position of the valve stem 17, and there is a need to decrease the measured valve opening in order to eliminate the error δ. For that reason, the second correction values α2 are set to the negative values so that the valve opening actual value θpr matches the corrected valve opening θpv′.

Meanwhile, in the first example (example shown in FIG. 2), when the changing direction of the valve opening is considered, the changing direction of the valve opening is determined in the valve opening measurement value correction portion 20C2, when the direction is changed to a direction of decreasing the valve opening, the correction value α is added to the valve opening measurement value θpv as a positive value, and when the direction is changed to a direction of increasing the valve opening, the correction value α is subtracted from the valve opening measurement value θpv as a negative value.

Also, in the examples described above, the correction value corresponding to the amount of twist of the valve stem 17 is set to the value corresponding to the combination of the valve opening of the valve member 14 with the differential pressure of the valve member 14, but may not be always set to the value corresponding to the combination of the valve opening of the valve member 14 with the differential pressure of the valve member 14.

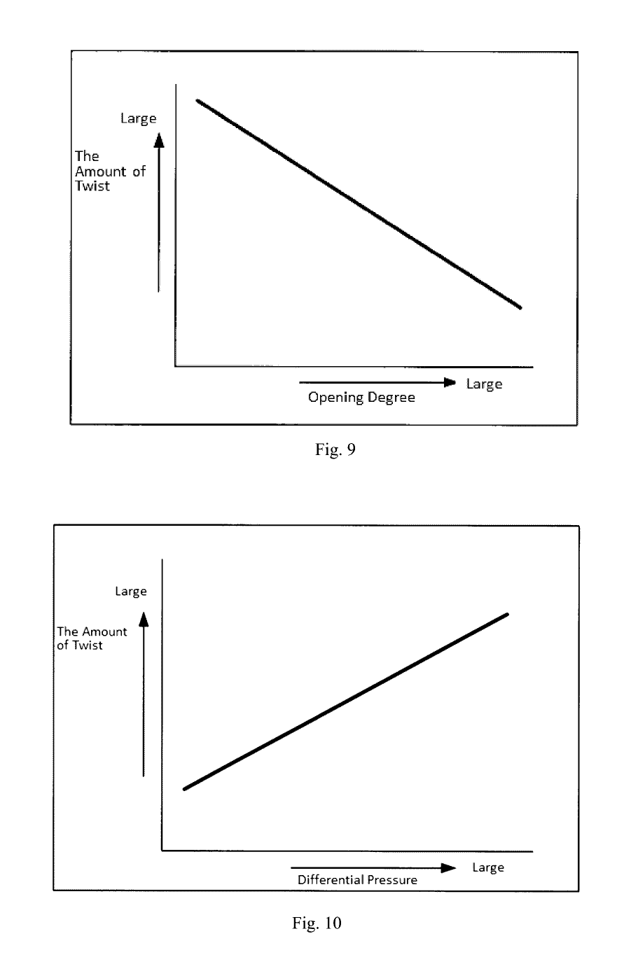

For example, the amount of twist of the valve stem 17 can be known from a relationship (refer to FIG. 9) between the valve opening of the valve member 14 and the amount of twist, or a relationship (refer to FIG. 10) between the differential pressure of the valve member 14 and the amount of twist. With the use of the above relationships, the correction value corresponding to the amount of twist of the valve stem 17 may be determined according to the valve opening of the valve member 14, or the correction value corresponding to the amount of twist of the valve stem 17 may be determined according to the differential pressure of the valve member 14.

Also, in the examples described above, the correction value corresponding to the amount of twist of the valve stem 17 is acquired from a table (table system), and alternatively, a formula is determined and the correction value may be obtained by calculation (arithmetic method). For example, the torque value generated in the valve stem 17 may be obtained according to the valve opening measurement value θpv and the differential pressure detection value ΔP, the amount of twist may be calculated on the basis of the torque value and the material and shape (member length, elastic modulus, cross-section secondary polar moment) of the valve stem 17 or the drive shaft 18-1, and the calculated amount of twist may be set as the correction value corresponding to the amount of twist of the valve stem 17 at that time. Further, when the amount of twist is calculated, the changing direction of the valve opening of the valve member 14 is determined, and the determined changing direction of the valve opening may be reflected on the calculated amount of twist. A general arithmetic expression of a twist angle is described below with Formula (2). Also, a correction table in which the amount of twist calculated from the torque value is set as the correction value may be stored in the correction table storage portion 20D.

θ=TI/GIp (2)

where θ is a twist angle, T is a torque, I is a member length, G is a transverse elastic modulus, and Ip is a cross-sectional secondary polar moment.

Alternatively, the correction value corresponding to the amount of twist of the valve stem 17 may be determined as a constant value, and the valve opening (valve opening measurement value) of the valve member 14 detected according to the rotational position of the valve stem 17 may be corrected with a constant value determined as the correction value corresponding to the amount of twist of the valve stem 17.

Alternatively, the correction value corresponding to the changing direction of the valve opening of the valve member 14 and the amount of twist of the valve stem 17 may be determined as a constant value, and the valve opening (valve opening measurement value) of the valve member 14 detected according to the rotational position of the valve stem 17 may be corrected with a constant value determined as the correction value corresponding to the changing direction of the valve opening of the valve member 14 and the amount of twist of the valve stem 17.

Further, in the examples described above, a use example in the air conditioning control system has been described, but the present disclosure can be applied to an industrial field. More specifically, the present disclosure is applicable to a flow rate controlling system of a process control. Further, the fluid is not limited to cold water or hot water, but applicable to a variety of fluids, such as gases.

### EXPANSION OF EXAMPLE

Although the disclosure has been described above with reference to an example, the disclosure is not limited to the above example. Various changes understandable to those skilled in the art can be made to the structure and details of the disclosure within the scope of the disclosure.

### DESCRIPTION OF REFERENCE NUMERALS AND SIGNS

8 . . . flow rate control valve (rotary valve), 8-1 . . . valve main body, 8-2 . . . actuator, 13 . . . pipeline, 14 . . . valve member, 15 . . . primary side pressure sensor, 16 . . . secondary side pressure sensor, 17 . . . valve stem, 18 . . . motor, 19 . . . valve opening detector, 20 . . . processing portion, 20A . . . valve opening controlling portion, 20B . . . differential pressure detection portion, 20C . . . valve opening correction portion, 20C1 correction value acquisition portion, 20C2 valve opening measurement value correction portion, 20D . . . correction table storage portion, TA . . . correction table, TA1 . . . correction table for changing closing direction (first correction table), TA2 . . . correction table for changing opening direction (second correction table), 20F . . . characteristic table storage portion, and TB . . . characteristic table.

1. A flow rate calculating device comprising:
a valve opening correction portion configured to:
obtain a correction value corresponding to an amount of twist of a valve stem according to at least one of a valve opening measurement value and a differential pressure detection value, wherein a valve opening of a valve member detected according to a rotational position of the valve stem coupled with the valve member that adjusts at least one of an opening and a closing amount of a flow channel in which a fluid flows is set as the valve opening measurement value and a differential pressure of the valve member detected as a pressure difference between a primary fluid pressure and a secondary fluid pressure of the valve member is set as the differential pressure detection value, and
correct the valve opening measurement value using the correction value; and
a flow rate calculation portion configured to calculate a flow rate of the fluid flowing in the flow channel based on a corrected valve opening measurement value corrected by the valve opening correction portion and the differential pressure detection value.

2. The flow rate calculating device according to claim 1, further comprising a correction table storage portion configured to store a correction table that determines the correction value corresponding to an amount of twist of the valve stem in correspondence with a combination of the valve opening of the valve member with the differential pressure detection value, wherein
the valve opening correction portion is further configured to acquire the correction value corresponding to a combination of the valve opening measurement value with the differential pressure detection value from the correction table, and correct the valve opening measurement value using the acquired correction value.

3. The flow rate calculating device according to claim 1, wherein
the valve opening correction portion is further configured to obtain a torque value generated in the valve stem according to the valve opening measurement value and the differential pressure detection value, obtain the correction value corresponding to an amount of twist of the valve stem by substituting the torque value to a predetermined arithmetic expression, and correct the valve opening measurement value using the obtained correction value.

4. A flow rate calculation method comprising the steps of:
acquiring, as a valve opening measurement value, a valve opening of a valve member detected according to a rotational position of a valve stem coupled with the valve member that adjusts at least one of an opening and a closing amount of a flow channel in which a fluid flows;
acquiring, as a differential pressure detection value, a differential pressure of the valve member detected as a pressure difference between a primary fluid pressure and a secondary fluid pressure of the valve member;
obtaining a correction value corresponding to an amount of twist of the valve stem according to at least one of the valve opening measurement value and the differential pressure detection value;
correcting the valve opening measurement value using the correction value; and
calculating a flow rate of the fluid flowing in the flow channel based on a corrected valve opening measurement value corrected by the correcting step and the differential pressure detection value.

5. A flow rate controlling device comprising:
a valve opening correction portion configured to:
obtain a correction value corresponding to an amount of twist of a valve stem according to at least one of a valve opening measurement value and a differential pressure detection value, wherein a valve opening of a valve member detected according to a rotational position of the valve stem coupled with the valve member that adjusts at least one of an opening and a closing amount of a flow channel in which a fluid flows is set as the valve opening measurement value and a differential pressure of the valve member detected as a pressure difference between a primary fluid pressure and a secondary fluid pressure of the valve member is set as the differential pressure detection value, and
correct the valve opening measurement value using the correction value;
a flow rate calculation portion configured to calculate a flow rate of the fluid flowing in the flow channel based on a corrected valve opening measurement value corrected by the valve opening correction portion and the differential pressure detection value; and
a valve opening controlling portion configured to control an amount of rotation of the valve stem so that a measured flow rate matches a set flow rate when the flow rate of the fluid calculated by the flow rate calculation portion is set as the measured flow rate.

6. A flow rate calculating device comprising:
a valve opening correction portion configure to correct a valve opening of a valve member detected according to a rotational position of a valve stem coupled with the valve member that adjusts at least one of an opening and a closing amount of a flow channel in which a fluid flows with a constant value determined as a correction value corresponding to an amount of twist of the valve stem; and
a flow rate calculation portion configured to calculate a flow rate of the fluid flowing in the flow channel based on the valve opening corrected by the valve opening correction portion and a differential pressure of the valve member detected as a pressure difference between a primary fluid pressure and a secondary fluid pressure of the valve member.

7. A flow rate calculating device comprising:
a valve opening correction portion configured to:
determine a changing direction of a valve opening of a valve member,
obtain at least one of a valve opening measurement value, a differential pressure detection value, and a correction value corresponding to an amount of twist of a valve stem according to the determined changing direction of the valve opening, wherein the valve opening of the valve member detected according to a rotational position of the valve stem coupled with the valve member that adjusts at least one of an opening and a closing amount of a flow channel in which a fluid flows is set as the valve opening measurement value and a differential pressure of the valve member detected as a pressure difference between a primary fluid pressure and a secondary fluid pressure of the valve member is set as the differential pressure detection value, and
correct the valve opening measurement value with the correction value; and
a flow rate calculation portion that calculates a flow rate of the fluid flowing in the flow channel based on a corrected valve opening measurement value corrected by the valve opening correction portion and the differential pressure detection value.

8. The flow rate calculating device according to claim 7, further comprising a correction table storage portion configured to store a correction table that determines a correction value corresponding to an amount of twist of the valve stem in correspondence with a combination of the valve opening of the valve member with the differential pressure of the valve member and the changing direction of the valve opening of the valve member, wherein
the valve opening correction portion is further configured to acquire the correction value corresponding to a combination of the valve opening measurement value with the differential pressure detection value and the determined changing direction of the valve opening from the correction table, and correct the valve opening measurement value using the acquired correction value.

9. The flow rate calculating device according to claim 7, wherein
the valve opening correction portion is further configured to obtain a torque value generated in the valve stem according to the valve opening measurement value and the differential pressure detection value, determine the changing direction of the valve opening of the valve member, obtain the correction value corresponding to an amount of twist of the valve stem by substituting the torque value and the determined changing direction of the valve opening to a predetermined arithmetic expression, and correct the valve opening measurement value using the obtained correction value.

10. A flow rate calculation method comprising the steps of:
acquiring, as a valve opening measurement value, a valve opening of a valve member detected according to a rotational position of a valve stem coupled with the valve member that adjusts at least one of an opening and a closing amount of a flow channel in which a fluid flows;
acquiring, as a differential pressure detection value, a differential pressure of the valve member detected as a pressure difference between a primary fluid pressure and a secondary fluid pressure of the valve member;
determining a changing direction of the valve opening of the valve member;
obtaining a correction value corresponding to an amount of twist of the valve stem according to at least one of the valve opening measurement value, the differential pressure detection value, and the changing direction of the valve opening;
correcting the valve opening measurement value using the correction value; and
calculating a flow rate of the fluid flowing in the flow channel based on a corrected valve opening measurement value corrected by the correcting step and the differential pressure detection value.

11. A flow rate controlling device comprising:
a valve opening correction portion configured to:
determine a changing direction of a valve opening of a valve member,
obtain a correction value corresponding to an amount of twist of a valve stem according to at least one of a valve opening measurement value, a differential pressure detection value, and the determined changing direction of the valve opening, wherein the valve opening of the valve member detected according to a rotational position of the valve stem coupled with the valve member that adjusts at least one of an opening and a closing amount of a flow channel in which a fluid flows is set as the valve opening measurement value and a differential pressure of the valve member detected as a pressure difference between a primary fluid pressure and a secondary fluid pressure of the valve member is set as the differential pressure detection value, and
correct the valve opening measurement value using the correction value;
a flow rate calculation portion configured to calculate a flow rate of the fluid flowing in the flow channel based on a corrected valve opening measurement value corrected by the valve opening correction portion and the differential pressure detection value; and
a valve opening controlling portion configured to control an amount of rotation of the valve stem so that a measured flow rate matches a set flow rate when the flow rate of the fluid calculated by the flow rate calculation portion is set as the measured flow rate.

12. A flow rate calculating device comprising:
a valve opening correction portion configured to correct a valve opening of a valve member detected according to a rotational position of a valve stem coupled with the valve member that adjusts at least one of an opening and a closing amount of a flow channel in which a fluid flows with a constant value determined as a correction value corresponding to a changing direction of the valve opening of the valve member and an amount of twist of the valve stem; and
a flow rate calculation portion configured to calculate a flow rate of the fluid flowing in the flow channel based on the valve opening corrected by the valve opening correction portion and a differential pressure of the valve member detected as a pressure difference between a primary fluid pressure and a secondary fluid pressure of the valve member.
